(19) United States
(12) Patent Application Publication
(10) Pub. No.: US 2008/0248881 A1
(43) Pub. Date: Oct. 9, 2008

(54) VIDEO GAME PROGRAM, VIDEO GAME DEVICE, AND VIDEO GAME CONTROL METHOD

(75) Inventor: Katsuyoshi ENDO, Osaka (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 12/139,864

(22) Filed: Jun. 16, 2008

Related U.S. Application Data
(63) Continuation of application No. PCT/JP2006/321236, filed on Oct. 25, 2006.

(30) Foreign Application Priority Data
Dec. 26, 2005 (JP) 2005-372070

(51) Int. Cl. G06F 17/00; A63F 9/24

(52) U.S. Cl. 463/43; 463/16; 463/37

(57) ABSTRACT

A video game program is provided that is capable of realizing a video game in which an object displayed on an image display unit is caused to move in conjunction with movement of a controller in which an acceleration sensor is embedded. According to the present game program, in time interval data recognizing means, a time interval of the acceleration data consecutively inputted into an operation input unit is recognized by a control unit as the time interval data. In acceleration data recognizing means, the acceleration data to be inputted into the operation input unit at the time interval of the acceleration data to be consecutively inputted into the operation input unit is recognized by the control unit. In velocity data calculating means, the velocity data is calculated by the control unit based on the acceleration data and the time interval data, both of which are recognized by the control unit. In object moving velocity data calculating means, the moving velocity data of the object is calculated by the control unit based on the velocity data. In object moving state displaying means, a state of the object moving at the velocity set by the moving velocity data is consecutively displayed on a television monitor with the image data corresponding to the object.

### CROSS-REFERENCE TO THE RELATED APPLICATION

This application claims priority to Japanese Patent Application No. 2005-372070 and International Patent Application No. PCT/JP2006/321236. The entire disclosure of Japanese Patent Application No. 2005-372070 and International Patent Application No. PCT/JP2006/321236 is hereby incorporated herein by reference.

### TECHNICAL FIELD

The preset invention relates to a video game program, particularly to a video game program for causing a computer to realize a video game in which an object is displayed on an image display unit and the object is caused to move in conjunction with movement of a controller based on the acceleration data detected by an acceleration sensor embedded in the controller. Also, the present invention relates to a video game device that is capable of executing the video game realized by the video game program, and relates to a game control method that is capable of controlling the video game to be realized by the video game program.

### BACKGROUND ART

Various games have been proposed in the past. The video games are configured to be executed in a game device. For example, a general game device includes a monitor, a game console that is provided separately from the monitor, and an input unit (e.g., a controller) that is provided separately from the game console. An input part (e.g., a plurality of input buttons) is disposed on the controller. A game device of this type is configured to be capable of causing an object displayed on the monitor to perform an action by manipulating the input buttons.

A situation is hereinafter considered that a versus-type game (e.g., baseball game) is executed in a game device of this type. In the baseball game, it is possible to cause an object displayed on a monitor (e.g., a bat of a batter character) to perform an action by manipulating input buttons. JIKKYOU PAWAFURU PURO YAKYU 9 KETTEIBAN, Konami Corporation, for PS2 discloses such game as an example. In this case, first of all, when up, down, right, and left portions of a cross-shaped button are pressed, a contact hitting cursor accordingly moves up, down, right, and left. Next, if an X button is pressed so that a bat is capable of hitting a ball when the ball released by a pitcher character reaches a ball passing position on a hitting surface, the batter character starts swinging the bat. Accordingly, the bat displayed on the monitor starts moving at the constant velocity. Then, if the timing when the released ball reaches the hitting surface and the timing when the bat reaches the hitting surface are matched within a predetermined time period, the released ball is hit back with the bat.

### DISCLOSURE OF THE INVENTION

In the conventional baseball game, if an X button is pressed so that a ball released by a pitcher character is capable of being hit with a bat when the ball reaches a hitting point, a batter character has been configured to start swinging and the bat displayed on a monitor is configured to move at a constant velocity. Therefore, if a game player learns the timing when the released ball reaches the hitting point, he/she is capable of hitting the released ball relatively easily. Accordingly, the conventional baseball game lacks of amusement perceived when a game player operates the batter character. Even if swing velocity is intended to be changed every time a pitcher releases a ball in order to solve the lack of amusement perceived when a game player operates a batter character, it has been difficult for a conventional game program, a conventional game device, and a conventional game control method to realize this.

An object of the present invention is to provide a video game program that is capable of realizing a video game in which an object displayed on an image display unit is caused to move in conjunction with movement of a controller. Also, it is an object of the present invention is to provide a video game device that is capable of executing the video game realized by the video game program, and a video game control method that is capable of controlling the video game realized by the video game program.

A video game program in accordance with a first aspect of the present invention is a program for causing a computer, in which an object is displayed on an image display unit and the object is caused to move in conjunction with movement of a controller based on the acceleration data detected by an acceleration sensor embedded in the controller, to realize the following functions.

(1) A time interval data recognizing function for causing a control unit to recognize a time interval of the acceleration data to be consecutively inputted into an input unit as the time interval data.

(2) An acceleration data recognizing function for causing the control unit to recognize the acceleration data to be consecutively inputted into the input unit at the time interval of the acceleration data to be consecutively inputted into the input unit.

(3) A velocity data calculating function for causing the control unit to calculate the velocity data based on the acceleration data and the time interval data, both of which are recognized by the control unit.

(4) An object moving velocity data calculating function for causing the control unit to calculate the moving velocity data of the object based on the velocity data.

(5) An object moving state displaying function for consecutively displaying a state of an object moving at the velocity set by the moving velocity data on the image display unit with the image data corresponding to the object.

According to the game to be realized by the program, in the time interval data recognizing function, the time interval of the acceleration data consecutively inputted into the input unit is recognized by the control unit as the time interval data. In the acceleration data recognizing function, the acceleration data to be consecutively inputted into the input unit at the time interval of the acceleration data to be consecutively inputted into the input unit is recognized by the control unit. In the velocity data calculating function, the velocity data is calculated by the control unit based on the acceleration data and the time interval data, both of which are recognized by the control unit. In the object moving velocity data calculating function, the object moving velocity data is calculated by the control unit based on the velocity data. In the object moving state displaying function, the state of the object moving at the velocity set by the moving velocity data is consecutively displayed on the image display unit with the image data corresponding to the object.

In an example of a baseball game to be realized by the game program, firstly, a time interval of the acceleration data to be consecutively inputted into the input unit through the controller is recognized by a CPU as the time interval data. Then, the acceleration data inputted into the input unit at the time interval of the acceleration data to be consecutively inputted into the input unit through the controller is recognized by the CPU. Next, the velocity data is calculated by the CPU based on the acceleration data and the time interval data, both of which are recognized by the CPU. Then, the moving velocity data of the bat is calculated by the CPU based on the velocity data. Finally, a state of the bat moving at the velocity set by the moving velocity data is consecutively displayed on a monitor with the image data corresponding to the bat. More specifically, it is possible to consecutively display the state of the bat moving at the velocity set by the moving velocity data on the monitor together with a batter character swinging the bat.

According to the game program, with the controller in which the acceleration sensor is embedded, it is possible to change the velocity at which an object image such as a bat image moves on a monitor based on the acceleration data from the controller. Accordingly, it is possible to enhance amusement aroused when a game player operates a batter character.

A video game program in accordance with a second aspect of the present invention is the game program of the first aspect, and realizes the following functions. According to the game program, in the velocity data calculating function, the velocity magnitude data is calculated by the control unit by causing the control unit to perform the integral calculation for the acceleration data to be consecutively inputted into the input unit with time interval data. In addition, in the object moving velocity data calculating function, the moving velocity data of the object corresponding to the velocity magnitude data is calculated by the control unit. Furthermore, in the object moving state displaying function, a state of the object moving at the velocity set by the moving velocity data is consecutively displayed on the image display unit with the image data corresponding to the object.

In this case, the velocity magnitude data is calculated by performing the integral calculation for the acceleration data with the time interval data, and the moving velocity data of the object corresponding to the velocity magnitude data is calculated. With the moving velocity data of the object, it is possible to consecutively display a state of the object such as a bat moving at the velocity set by the moving velocity data on a monitor with the image data corresponding to the bat. For example, a state of the bat moving at the velocity set by the moving velocity data is consecutively displayed on the monitor together with a batter character swinging the bat. Accordingly, it is possible to change the velocity of an object image such as a bat image moving on the monitor in conjunction with the moving velocity of the controller, and accordingly it is possible to enhance amusement aroused when a game player operates a batter character.

A video game program in accordance with a third aspect of the present invention is the game program of the second aspect, and realizes the following functions. According to the game program, in the velocity data calculating function, the velocity magnitude data is calculated by the control unit by causing the control unit to perform the integral calculation for the acceleration data to be consecutively inputted into the input unit with the time interval data. Then, the position data of the controller is calculated by the control unit by causing the control unit to perform the integral calculation for the velocity magnitude data with the time interval data. In addition, in the object moving velocity data calculating function, the moving velocity data of the object corresponding to the velocity magnitude data is calculated by the control unit. Furthermore, in the object moving state displaying function, the calculation of converting the position data of the controller into the position data of the image display unit is performed by the control unit. Then, the direction data for the object display is calculated by the control unit with the converted position data of the image display unit. Then, a state of an object moving at the velocity set by the moving velocity data in the direction set by the direction data for the object display is consecutively displayed on the image display unit with the image data corresponding to the object.

In this case, the position data of the controller is calculated by sequentially performing the integral calculations for the acceleration data and the velocity magnitude data with the time interval data. Then, the moving velocity data of the object corresponding to the velocity magnitude data is calculated by the control unit, and the position data of the controller is converted into the position data of the image display unit. Then, the direction data for the object display is calculated with the converted position data of the image display unit. With the moving velocity data of the object and the direction data for the object display, it is possible to consecutively display a stet of the object such as a bat moving at the velocity set by the moving velocity data in the direction set by the direction data for the object display on the monitor with the image data corresponding to the bat. For example, a state of a bat moving at the velocity set by the moving velocity data in the direction set by the direction data for the object display is consecutively displayed on a monitor together with a batter character swinging the bat. Accordingly, it is possible to change the velocity at which an object image such as a bat image moves on the monitor in conjunction with the moving velocity of the controller, and it is also possible to change the direction in which the bat image moves on the monitor in conjunction with the direction in which the controller is moved.

The video game program in accordance with a fourth aspect of the present invention is the game program of the first aspect, and realizes the following functions. According to the game program, in the acceleration data recognizing function, it is judged by the control unit whether or not a value of the acceleration data recognized by the control unit is greater than or equal to a predetermined value. Then, if it is judged by the control unit that the value of the acceleration data recognized by the control unit is greater than or equal to the predetermined value, the acceleration data is recognized by the control unit.

In this case, if it is judged by the control unit that the acceleration data recognized by the control unit is greater than or equal to the predetermined value, the acceleration data is configured to be recognized by the control unit. Therefore, even if a game player slightly moves a controller, it is possible to configure the object such as a bat not to move in conjunction with movement of the controller. In other words, it is possible to prevent an error manipulation that is caused when the game player involuntarily moves the controller.

A video game program in accordance with a fifth aspect of the present invention is the game program of the second aspect, and realizes the following functions. According to the game program, in the object moving velocity data calculating function, the object moving velocity data is calculated by the control unit by multiplying the velocity magnitude data by the modification coefficient for the image display.

In this case, the object moving velocity data is configured to be calculated by the control unit by multiplying the velocity magnitude data of a controller by the modification coefficient for the image display. Therefore, it is possible to cause the object such as a bat to move at the velocity depending on a game executed on a monitor. In other words, it is possible to modify the moving velocity of the controller into the optimal velocity for causing the bat to move in an object game such as a baseball game.

A video game program in accordance with a sixth aspect of the present invention is the game program of the second aspect, and realizes the following functions. According to the game program, in the object moving velocity calculating function, the moving velocity data of the object corresponding to the velocity magnitude data is calculated by the control unit based on a correspondence table of the velocity magnitude data and the moving velocity of the object on the image display unit.

In this case, the moving velocity data of the object corresponding to the velocity magnitude data is configured to be calculated by the control unit based on the correspondence table of the velocity magnitude data and the moving velocity of the object on the image display unit. Therefore, it is possible to cause the object such as a bat to move at the moving velocity depending on a game executed on a monitor. In other words, it is possible to modify the moving velocity of the controller into the optimal velocity for causing the bat to move in an object game such as a baseball game.

A game device in accordance with a seventh aspect of the present invention is a video game device that is capable of executing a video game in which an object is displayed on an image display unit and the object is caused to move in conjunction with movement of a controller based on acceleration data detected by an acceleration sensor embedded in the controller. The video game device includes time interval data recognizing means for causing a control unit to recognize a time interval of the acceleration data to be consecutively inputted into an input unit as the time interval data, acceleration data recognizing means for causing the control unit to recognize the acceleration data to be consecutively inputted into the input unit, velocity data calculating means for causing the control unit to calculate the velocity data based on the acceleration data and the time interval data, both of which are recognized by the control unit, object moving velocity data calculating means for causing the control unit to calculate the moving velocity data of the object based on the velocity data, and object moving state displaying means for consecutively displaying a state of the object moving at the velocity set by the moving velocity data on the image display unit with the image data corresponding to an object.

A video game control method in accordance with an eight aspect of the present invention is a video game control method for allowing a computer to control a video game in which an object is displayed on an image display unit and the object is caused to move in conjunction with movement of a controller based on the acceleration data detected by an acceleration sensor embedded in the controller. The video game control method includes recognizing acceleration of an input device, recognizing time duration of the acceleration, calculating velocity of the input device on the basis of the acceleration and the time duration, calculating velocity of the object based on the velocity of the input device, and code for displaying the object moving at the velocity of the object on the image display unit.

### BRIEF DESCRIPTION OF THE DRAWINGS

Referring now to the attached drawings which form a part of this original disclosure.

FIG. 1 is a basic configuration diagram of a video game device in accordance with an embodiment of the present invention.

FIG. 2 is a functional block diagram as an example of the video game device.

FIG. 3 is a diagram for illustrating characters displayed on a television monitor.

FIG. 4 is a diagram for illustrating correspondence between a moving state of a controller and a moving state of a bat.

FIG. 5 is a diagram for illustrating a direction in which a ball is hit by a bat.

FIG. 6 is a diagram for illustrating velocity at which a ball is hit by a bat.

FIG. 7 is a diagram for illustrating relation between the acceleration data and the velocity data.

FIG. 8 is a chart for illustrating functional relation when the position data of a controller is converted into the position data for a television monitor.

FIG. 9 is a flowchart for illustrating a bat swing velocity changing system.

FIG. 10 is a flowchart for illustrating the bat swing velocity changing system.

### DETAILED DESCRIPTION OF THE PREFERRED EMBODIMENTS

### Configuration and Operation of Game Device

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

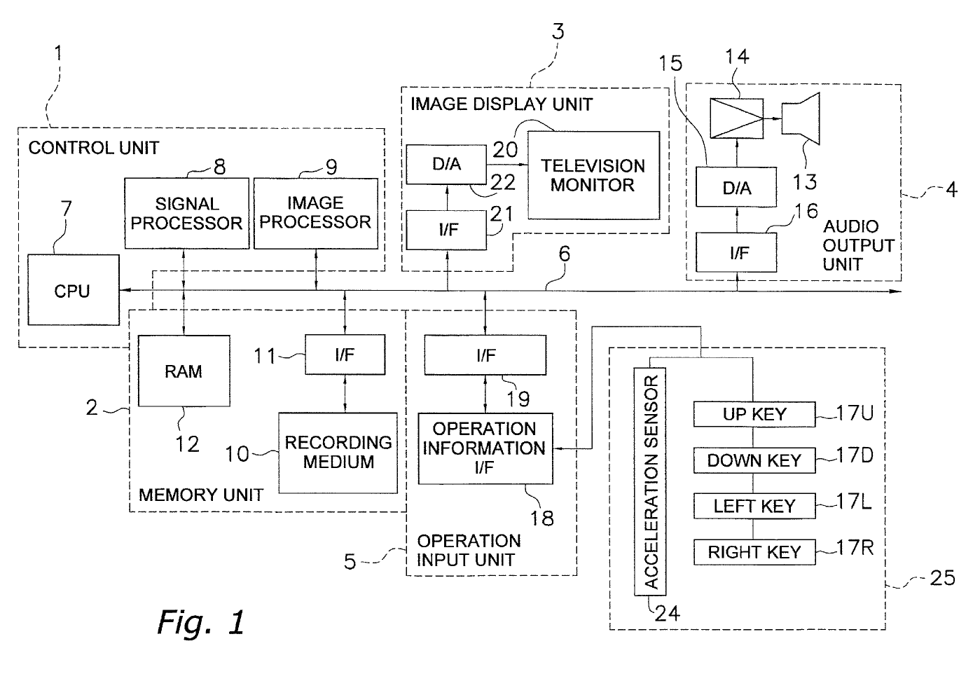

FIG. 1 shows the basic configuration of a game device in accordance with an embodiment of the present invention. As an example of a video game device, a home video game device will be hereinafter explained. The home video game device includes a home video game console and a home television set. A recording medium 10 is configured to be allowed to be loaded in the home video game console. Game data is arbitrarily read out of the recording medium 10 and a game is executed. The content of the game executed herewith is displayed on the home television set.

The game system of the home video game device is made up of a control unit 1, a storage unit 2, an image display unit 3, an audio output unit 4, and an operation input unit 5, and these units are connected to each other through a bus 6. This bus 6 includes an address bus, a data bus, a control bus, and the like. Here, the control unit 1, the storage unit 2, the audio output unit 4, the operation input unit 5, and a controller 25 are included in the home video game console of the home video game device, and the image display unit 3 is included in the home television set.

The control unit 1 is provided for mainly controlling progress of the entire game based on the game program. The control unit 1 is made up of a CPU (Central Processing Unit) 7, a signal processor 8, and an image processor 9, for instance. The CPU 7, the signal processor 8, and the image processor 9 are connected to each other through the bus 6. The CPU 7 interprets a command from a game program and performs a variety of data processing and data control. For example, the CPU 7 commands the signal processor 8 to provide the image data to the image processor. The signal processor 8 mainly performs computations in the three-dimensional space, computations of positional conversion from the three-dimensional space to the virtual three-dimensional space, a light source computation processing, and data generation and data processing of the image data and the audio data. The image processor 9 mainly performs a processing to write the image data to be rendered to a RAM 12 based on the computation results and processing results of the signal processor 8.

The memory unit 2 is provided mainly for storing the program data, various types of data used for the program data, and the like. The memory unit 2 is made up of the recording medium 10, an interface circuit 11, and the RAM (Random Access Memory) 12, for instance. The interface circuit 11 is connected to the recording medium 10. The interface circuit 11 and the RAM 12 are connected through the bus 6. The recording medium 10 serves to store the program data of the operating system, the game data made up of the image data, the audio data, various types of program data, and the like. For example, this recording medium 10 is a ROM (Read Only Memory) cassette, an optical disk, a flexible disk, or the like. The program data of the operating system, the game data, and the like are stored in this recording medium 10. Note that a card memory is also included in the category of the recording medium 10 and is mainly used for storing various game parameters at the point of interruption when the game is interrupted. The RAM 12 is used for temporarily storing various types of data read out of the recording medium 10, and for temporarily recording the processing results from the control unit 1. In addition to various types of data, the address data indicating the memory location of various types of data is stored in the RAM 12, and it is configured to be allowed to specify an arbitrary address and read/write data from/to the address.

The image display unit 3 is provided for mainly outputting the image data written to the RAM 12 by the image processor 9, the image data to be read out of the recording medium 10, and the like, as an image. The image display unit 3 is made up of a television monitor 20, an interface circuit 21, and a D/A converter (Digital-to-Analog converter) 22, for instance. The D/A converter 22 is connected to the television monitor 20, and the interface circuit 21 is connected to the D/A converter 22. In addition, the bus 6 is connected to the interface circuit 21. Here, the image data is provided to the D/A converter 22 through the interface circuit 21, and is herein converted into an analog image signal. Then, the analog image signal is outputted to the television monitor 20 as an image.

Here, the image data includes the polygon data, the texture data, and the like, for instance. The polygon data is the coordinate data of apexes forming the polygon. The texture data is used for setting texture with respect to the polygon, and is made up of the texture specifying data and the texture color data. The texture specifying data is the data for associating the polygon and the texture, and the texture color data is the data for specifying the texture color. Here, the polygon address data and the texture address data, both of which indicate the memory location of each type of data, are associated with the polygon data and the texture data, respectively. With the image data of this type, the coordinate conversion and the perspective projection conversion are performed with respect to the polygon data in the three-dimensional space (i.e., the three-dimensional polygon data) indicated with the polygon address data by the signal processor 8, based on the displacement data and the rotational data of the screen itself (i.e., point of sight). Accordingly, the polygon data is converted into the polygon data in the two-dimensional space (i.e., the two-dimensional polygon data). Then, a polygon outline is constituted with a plurality of two-dimensional polygon data, and the texture data specified by the texture address data is written to the internal area of the polygon. Thus, it is possible to express objects made by applying texture to each polygon, that is, various characters.

The audio output unit 4 is provided mainly for outputting the audio data to be read out of the recording medium 10 as the audio. The audio output unit 4 is made up of a speaker 13, an amplifier circuit 14, a D/A converter 15, and an interface circuit 16, for instance. The amplifier circuit 14 is connected to the speaker 13. The D/A converter 15 is connected to the amplifier circuit 14. The interface circuit 16 is connected to the D/A converter 15. In addition, the bus 6 is connected to the interface circuit 16. Here, the audio data is provided to the D/A converter 15 through the interface circuit 16 and is converted into an analog audio signal. The analog audio signal is amplified by the amplifier circuit 14 and is outputted from the speaker 13 as the audio. ADPCM (Adaptive Differential Pulse Code Modulation) data, PCM (Pulse Code Modulation) data, and the like are included in the category of the audio data, for instance. In the case of the ADPCM data, it is possible to output the audio from the speaker 13 with almost the same type of processing method as described above. In the case of the PCM data, it is possible to output the audio from the speaker 13 with almost the same type of processing method as described above by preliminarily converting the PCM data into the ADPCM data in the RAM 12.

The operation input unit 5 is mainly made up of an operation information interface circuit 18 and an interface circuit 19. The controller 25 is connected to the operation information interface circuit 18, and the interface circuit 19 is connected to the operation information interface circuit 18. In addition, the bus 6 is connected to the interface circuit 19.

The controller 25 is an operating device used by a game player for the purpose of inputting a variety of operating commands, and transmits an operating signal corresponding to a game player's operation to the CPU 7. An acceleration sensor 24 is embedded in the controller 25. For example, a piezo resistance sensor, a capacitance sensor, a magnetic sensor, and the like are included in the category of the acceleration sensor 24. When the controller 25 is moved, magnitude of acceleration of the controller 25 is measured and outputted by the acceleration sensor 24 of this type depending on movement of the controller 25. The acceleration sensor 24, which is herein used, is a triaxial acceleration sensor, and magnitude of accelerations in the triaxial directions are measured and outputted by the acceleration sensor 24 depending on movement of the controller 25. In other words, when the controller 25 is moved, magnitudes of accelerations in the triaxial directions from the acceleration sensor 24 are outputted as the acceleration data from the controller 25 to the operation input unit 5. It is possible to cause the control unit 1 to recognize movement of the controller 25 in the three-dimensional space by causing the control unit 1 to recognize and process the acceleration data.

Also, the controller 25 is provided with, for instance, a cross-shaped direction key made up of an up key 17U, a down key 17D, a left key 17L, and a right key 17R. For example, it is possible to move a character, an object, and a cursor on the screen of the television monitor 20 up, down, left, and right by the manipulation of the up key 17U, the down key 17D, the left key 17L, and the right key 17R. When the up key 17U, the down key 17D, the left key 17L, and the right key 17R are respectively manipulated, an operating signal corresponding to each of the keys is outputted from the controller 25 to the operation input unit 5, and a command corresponding to the operating signal is recognized by the control unit 1.

Note that each button and each key provided in the controller 25 are configured to function as ON/OFF switches that become an on-state when pressed from the neutral position by the external pressure and become an off-state by returning to the neutral position when the pressure is released.

The general operations of the home video game device configured as described above will be hereinafter explained. If a power switch (not illustrated in the figure) is turned on and accordingly the game system 1 is powered on, the CPU 7 reads out the image data, the audio data, and the program data from the recording medium 10 based on the operating system stored in the recording medium 10. All or part of the read-out data including the image data, the audio data, and the program data are stored in the RAM 12. Then, the CPU 7 issues commands to the image data and the audio data, both of which are stored in the RAM 12, based on the program data stored in the RAM 12.

In the case of the image data, the signal processor 8 firstly performs the positional computation, the light source computation, and the like for a character in the three-dimensional space based on the command from the CPU 7. Next, the image processor 9 performs a processing of writing the image data to be rendered to the RAM 12 based on the computation results by the signal processor 8. Then, the image data written to the RAM 12 is provided to the D/A converter 15 through the interface circuit 16. Here, the image data is converted into an analog image signal by the D/A converter 15. Then, the image data is provided to the television monitor 20 and is displayed as an image.

In the case of the audio data, the signal processor 8 firstly performs processing to generate and process the audio data based on the command from the CPU 7. Here, processing, such as the pitch conversion, the noise addition, the envelope setting, the level setting, and the reverb addition, is performed for the audio data. Next, the audio data is outputted from the signal processor 8 and is provided to the D/A converter 15 through the interface circuit 16. Here, the audio data is converted into an analog audio signal. Then, the audio data is outputted as the audio from the speaker 13 through the amplifier circuit 14.

### Summary of a Variety of Processing in Game Device

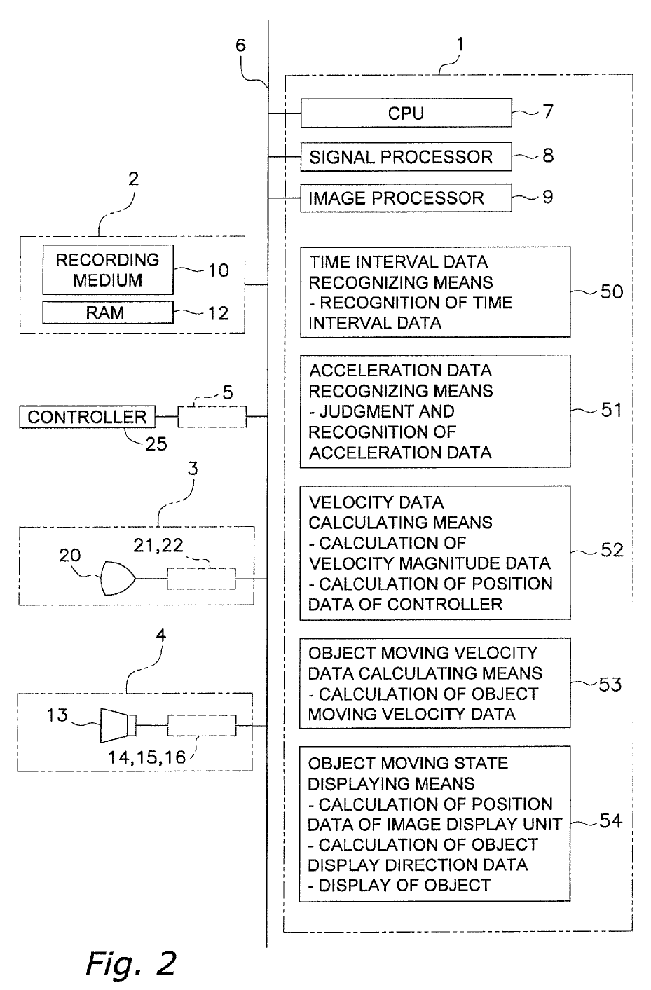

A game executed in a present game consol 1 is a baseball game, for instance. The present consol 1 is configured to be capable of realizing a vide game in which an object is displayed on a television monitor 20 of the image display unit 3, and the object is caused to move in conjunction with movement of the controller 25 based on the acceleration data detected by the acceleration sensor 24 embedded in the controller 25. FIG. 2 is a functional block diagram for illustrating functions that play major roles in the present invention.

Time interval data recognizing means 50 has a function of causing a control unit 1 to recognize a time interval of the acceleration data, which is consecutively inputted into the operation input unit 5, as the time interval data.

In the time interval data recognizing means 50, the time interval of the acceleration data, which is consecutively inputted into the operation input unit 5, is recognized as the time interval data by the control unit 1.

Acceleration data recognizing means 51 has a function of causing the control unit 1 to recognize the acceleration data that is consecutively inputted into the operation input unit at the time interval set by the time interval data.

In the acceleration data recognizing means 51, the acceleration data recognized by the control unit 1 are recognized by the control unit 1. Specifically, in the acceleration data recognizing means 51, it is judged by the control unit 1 whether or not a value of the acceleration data recognized by the control unit 1 is greater than or equal to a predetermined value. Then, if it is judged by the control unit 1 that the acceleration data recognized by the control unit 1 is greater than or equal to a predetermined value, the acceleration data is recognized by the control unit 1.

Velocity data calculating means 52 has a function of causing the control unit 1 to calculate the velocity data based on the acceleration data and the time interval data, both of which are recognized by the control unit 1.

In the velocity data calculating means 52, the velocity data is calculated by the control unit 1 based on the acceleration data and the time interval data, both of which are recognized by the control unit 1. Specifically, in the velocity data calculating means 52, the velocity magnitude data is calculated by the control unit 1 when the integral calculation is performed for the acceleration data consecutively inputted into the operation input unit 5 by the control unit 1 with the time interval data. More specifically, in the velocity data calculating means 52, the velocity magnitude data is calculated by the control unit 1 when the integral calculation is performed for the acceleration data consecutively inputted into the operation input unit 5 by the control unit with the time interval data. Then, the position data of the controller 25 is calculated by the control unit 1 when the integral calculation is performed for the velocity magnitude data by the control unit 1 with the time interval data.

Object moving velocity data calculating means 53 has a function of causing the control unit 1 to calculate the moving velocity data of an object based on the velocity data.

In the object moving velocity data calculating means 53, the moving velocity data of the object is calculated by the control unit 1 based on the velocity data. Specifically, in the object moving velocity data calculating means 53, the moving velocity data of the object, which corresponds to the velocity magnitude data, is calculated by the control unit 1. More specifically, in the object moving velocity data calculating means 53, the moving velocity data of the object is calculated by the control unit 1 when the calculation for multiplying the velocity magnitude data by modification coefficient for the image display is performed by the control unit 1. Note that in the present embodiment, an example is described that the moving velocity data of the object is calculated by multiplying the velocity magnitude data by the modification coefficient for the image display. However, under the condition that a correspondence table between the velocity magnitude and the moving velocity of the object on the television monitor 20 of the image display unit 3 (velocity given by multiplying the velocity magnitude by the modification coefficient) is preliminarily set in the game program, the moving velocity data of the object, which corresponds to the velocity magnitude data, may be configured to be selected by the control unit 1 based on a correspondence table that is provided to the memory unit 2 from the recording medium 10 when the game program is loaded.

Object moving state displaying means 54 has a function of consecutively displaying a state of an object moving at the velocity set by the moving velocity data on the television monitor 20 of the image display unit 3 with the image data corresponding to the object.

In the object moving state displaying means 54, a state of the object moving at the velocity set by the moving velocity data is consecutively displayed on the television monitor 20 of the image display unit 3 with the image data corresponding to the object. Specifically, in the object moving state displaying means 54, the calculation for converting the position data of the controller 25 to the position data for the television monitor 20 is performed by the control unit 1. Then, the direction data for the object display is calculated by the control unit 1 with the position data for the television monitor 20 obtained by the conversion. Then, a state of the object moving at the velocity set by the moving velocity data in a direction set by the direction data for the object display is consecutively displayed on the television monitor 20 of the image display unit 3 with the image data corresponding to the object. In the object moving state displaying means 54, a state of the object moving at the velocity set by the moving velocity data is displayed on the television monitor 20 of the image display unit 3 by consecutively displaying the image data corresponding to the object on the television monitor 20 of the image display unit 3 at a rendering time interval set by the rendering time interval data corresponding to the moving velocity data, such as 0.02 seconds (50 frames per second).

### Summary and a Variety of Processing Flow of Bat Swing Velocity Changing System in Baseball Game

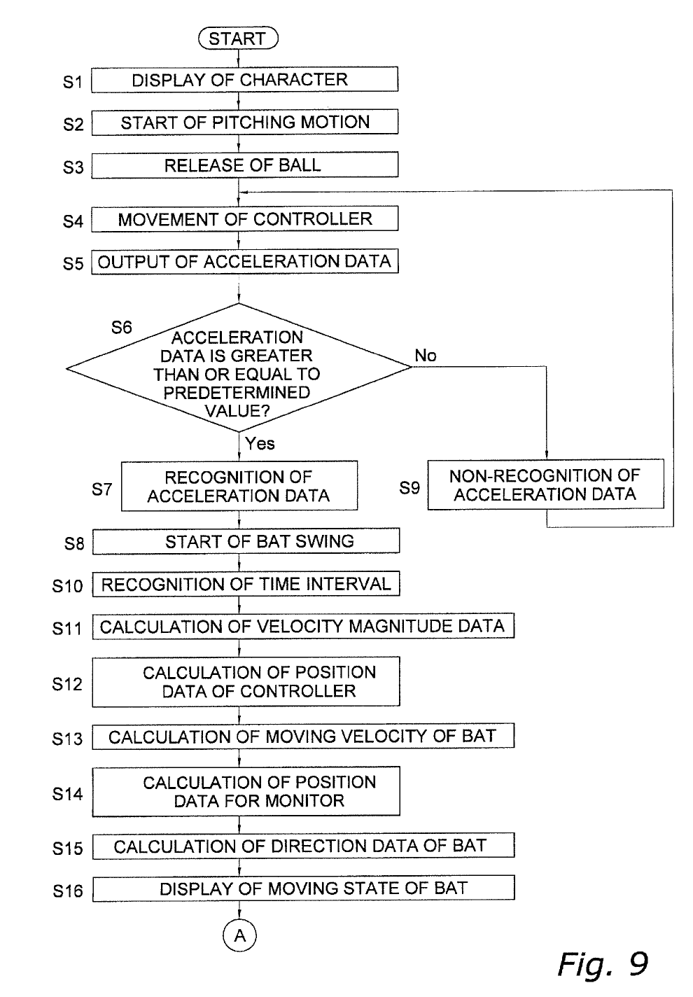

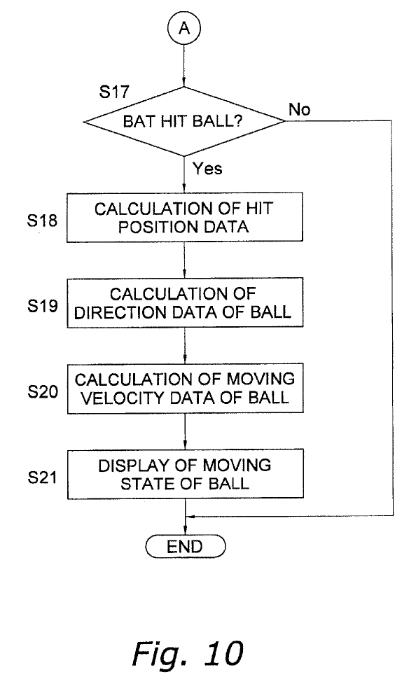

Summary of a bat swing velocity changing system in the baseball game will be hereinafter explained. In addition, a flow of the bat swing velocity changing system illustrated in FIG. 9 will be also simultaneously explained.

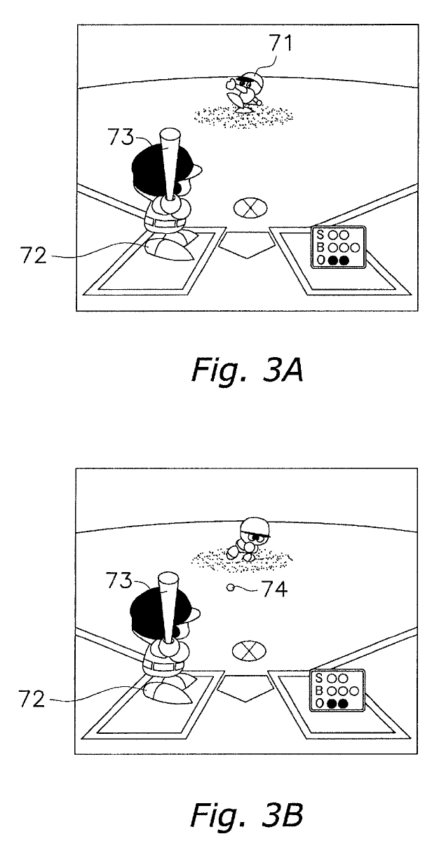

As illustrated in FIG. 3, when a game player operates a batter character in the present baseball game, a pitcher character 71 and a batter character 72 holding a bat are displayed on the television monitor 20 (S1). Here, when a command for causing the pitcher character 71 to perform an action is issued by the control unit 1 based on the game program, a state of the pitcher character 71 performing a pitching motion is displayed on the television monitor 20 by causing the image data corresponding to the batter character 72, such as the polygon data, to consecutively move (S2). Then, when a predetermined pitching motion of the pitcher character 71 is completed, a command for causing the pitcher character 71 to release a ball is issued by the control unit 1. Accordingly, a state that a ball character 74 released from the pitcher character 71 moves from the pitcher character 71 to the batter character 72 is displayed on the television monitor 20 (S3). The state is realized by causing the image data corresponding to the ball character 74 to move from the pitcher character 71 toward the batter character 72. Here, movement of the ball character 74 is controlled by the control unit 1.

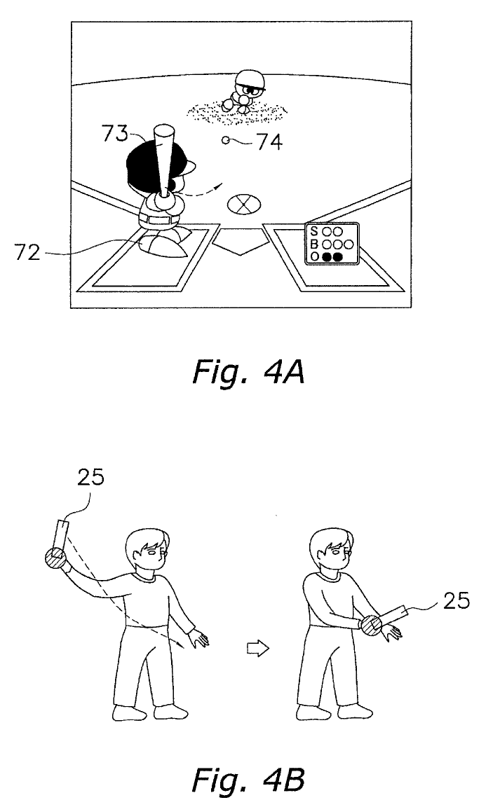

As illustrated in FIG. 4, if a game player moves the controller 25 (e.g., game player swings his/her arm together with the controller 25 while holding the controller 25: S4) while a state that the ball character 74 released from the pitcher character 71 moves from the pitcher character 71 to the batter character 72 is displayed on the television monitor 20, the acceleration data detected by the acceleration sensor 24 embedded in the controller 25 is consecutively outputted from the controller 25 to the operation input unit 5, and are inputted into the operation input unit 5 (S5).

Accordingly, it is judged by the control unit 1 whether or not the absolute value of the acceleration data recognized by the control unit 1 is greater than or equal to a predetermined value (S6). If it is judged by the control unit 1 that the absolute value of the acceleration data is greater than or equal to a predetermined value (Yes in S6), the acceleration data is recognized by the control unit 1 (S7). Accordingly, a state of the bat that starts moving together with the batter character 72, that is, a state of the batter character 72 that starts swinging the bat, is displayed on the television monitor 20 by causing the image data such as the polygon data to consecutively move (S8). Here, if it is judged by the control unit 1 that the absolute value of the acceleration data inputted into the operation input unit 5 is less than a predetermined value (No in S6), the acceleration data is not recognized by the control unit 1 (S9). In other words, the bat does not start moving together with the batter character 72 (the batter character 72 does not start swinging the bat).

When the acceleration data is recognized by the control unit 1, the time interval of the acceleration data, which is consecutively inputted into the operation input unit 5, is recognized by the control unit 1 as the time interval data (S10). Accordingly, the integral calculation is performed for the acceleration data consecutively inputted into the operation input unit 5 by the control unit 1 with the time interval data, and the velocity magnitude data is calculated by the control unit 1 (S11). Also, the integral calculation is performed for the velocity magnitude data by the control unit 1 with the time interval data, and the position data of the controller 25 is calculated by the control unit 1 (S12). Furthermore, the calculation for multiplying the velocity magnitude data by the modification coefficient for the image display is performed by the control unit 1, and the bat moving velocity data is calculated by the control unit 1 (S13).

Accordingly, the calculation for converting the position data of the controller 25 to the position data for the television monitor 20 is performed by the control unit 1 (S14), the direction data for the bat is calculated by the control unit 1 with the position data for the television monitor 20 (S15). Accordingly, a state of the bat moving at the velocity set by the moving velocity data in the direction set by the direction data for the bat, that is, a state of the batter character 72 swinging the bat in conjunction with movement of the controller 25, is displayed on the television monitor 20 by consecutively moving the image data such as the polygon data (S16). The state is realized by causing the image data of the batter character 72 holding the bat such as the polygon data to consecutively move on the television monitor 20 at the rendering time interval set by the rendering time interval data so that the bat moves at the velocity set by the moving velocity data in the direction set by the direction data for the bat. The rendering time interval data is regulated by the control unit 1 in accordance with the velocity magnitude data. For example, the polygon data is displayed on the television monitor 20 by preliminarily setting the reference moving velocity and the reference rendering time interval of the bat of the game in the game program. Based on the reference state, if the moving velocity of the bat is faster than the reference moving velocity, the polygon data is displayed on the television monitor 20 at a time interval shorter than a period of 0.02 seconds. On the other hand, if the bat moving velocity is slower than the reference moving velocity, the polygon data is displayed on the television monitor 20 at a time interval greater than the time interval of 0.02 seconds. Here, the rendering time interval is calculated by multiplying the reference time interval (here, 0.02 seconds) by rate (ratio) of the calculated bat moving velocity with respect to the reference moving velocity.

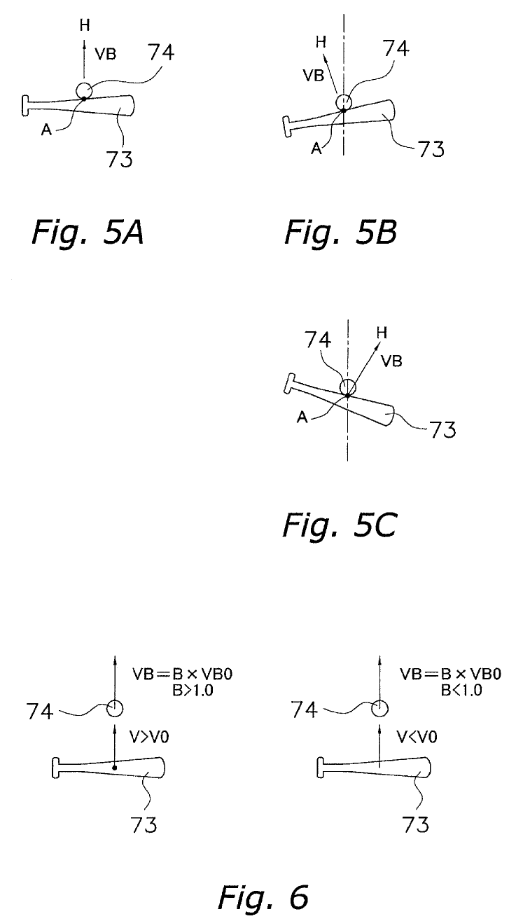

Then, it is judged by the control unit 1 whether or not the bat character 73 is positioned within an area in which the bat character 73 is capable of hitting back the ball character 74 (S17). Then, if it is judged by the control unit 1 that the bat character 73 is positioned within the area in which the bat character 73 is capable of hitting back the ball character 74 (Yes in S17), as illustrated in FIG. 5, the hitting position data for setting a position A in which the ball and the bat hit is calculated by the control unit 1 (S18). The hit back direction data of the ball hitting against the bat is calculated by the control unit 1 depending on a coordinate of the hit position A set by the position data (S19). Here, the ball moving velocity data is calculated by the control unit 1 depending on velocity V set by the bat moving velocity data (S20). Then, a state of the ball character 74 moving at velocity VB set by the ball moving velocity data in a direction H set by the hit back direction data of the ball is consecutively displayed on the television monitor 20 with the image data corresponding to the ball character 74 (S21).

Note that the hit position data regarding the position that the ball and the bat hit is the data for judging the timing when the ball hits the bat. As the hit position A set by the hit position data is closer to the pitcher side, the timing when the ball hits the bat is configured to be earlier (see FIG. 5(b)). On the other hand, as the hit position set by the hit position data is closer to the catcher side, the timing when the ball hits the bat is configured to be later (see FIG. 5(c)). With the above described series of processing, it is possible to change the direction of the ball that is hit back with the bat in accordance with the timing when the ball hits the bat, and it is possible to change the moving velocity of the ball that is hit back with the bat depending on the moving velocity of the bat.

For example, under the condition that a batter character is right-handed batter, the moving direction of the ball is configured to be the direction of the center field when the timing when the bat hits the ball is within a range of a predetermined timing (when the hit position set by the hit position data is within a predetermined area on the home plate). Also, if the timing when the bat hits the ball is early, the moving direction of the ball is configured to be the direction of the left field. If the timing when the bat hits the ball is late, the moving direction of the ball is configured to be the direction of the right field (see FIG. 5(b) and FIG. 5(c)).

Also, as illustrated in FIG. 6, when the ball is hit back while the moving velocity V of the bat is great, the moving velocity VB of the ball to be hit back with the bat becomes great. When the ball is hit back while the moving velocity V of the bat is less, the moving velocity VB of the ball to be hit back with the bat becomes less. Here, magnitude of the moving velocity of the ball to be hit back with the bat is calculated by the control unit 1 while the moving velocity V0 of the ball to be hit back with the bat when the bat is swung at the conventional constant velocity is used as the reference.

For example, under the condition that the reference moving velocity of the ball that is hit back with the bat when the bat is swung at the conventional constant velocity V0 is set to be VB0, when the ball is hit back while the moving velocity V of the bat is greater than the constant velocity V0 (V>V0), the reference moving velocity VB0 of the ball to be hit back with the bat is corrected by the control unit 1 depending on the magnitude of the velocity (V−V0), and the moving velocity VB of the ball (β·VB0: β>1.0) is calculated. Also, when the ball is hit back while the moving velocity V of the bat is less than the constant velocity V0 (V<V0), the reference moving velocity VB0 of the ball to be hit back with the bat is corrected by the control unit 1 depending on the magnitude of the velocity (V0−V), and the moving velocity VB of the ball (β·VB0: β<1.0) is calculated. Here, relation between ↑V−V0| and correction coefficient β is preliminarily set in the game program, and the correction coefficient β corresponding to |V-V0| is selected by the control unit 1 based on a correspondence table to be provided from the recording medium 10 to the memory unit 2 when the game program is loaded.

### Contents of Processing in Each Means of Bat Swing Velocity Changing System and Supplementary Explanation Thereof

Contents of a variety of processing in the bat swing velocity changing system will be hereinafter explained in detail.

### Acceleration Data Recognizing Means

The acceleration sensor 24 is capable of detecting magnitude of accelerations in triaxial directions. For example, the acceleration sensor 24 detects acceleration value G (gx, gy, gz) in the range of “−3.0 g≦(gx, gy, gz)≦3.0 g”. Under the condition that the acceleration sensor 24 is embedded in the controller 25, it is judged by the control unit 1 whether or not the absolute value of the acceleration data inputted from the controller 25 into the operation input unit 5 is “G≧|0.2|g” when the controller 25 is moved from the static condition.

Here, if it is judged by the control unit 1 that the absolute value of the acceleration data inputted into the operation input unit 5 is “G≧|0.21|g”, the acceleration data is recognized by the control unit 1. On the other hand, if it is judged by the control unit 1 that the absolute value of the acceleration data inputted into the operation input unit 5 is “G<|0.21|g”, the acceleration data is not recognized by the control unit 1.

### Velocity Data Calculating Means

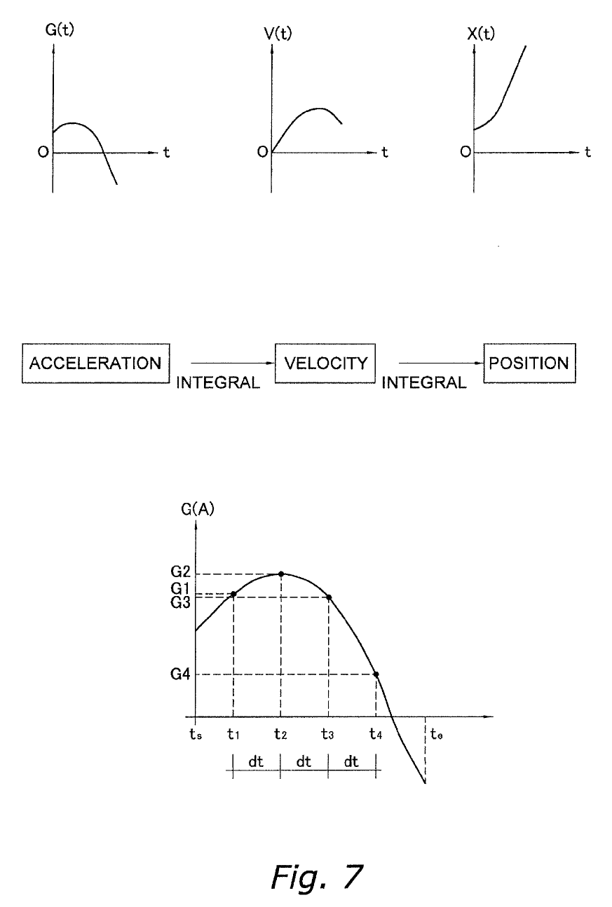

When the acceleration data G made up of magnitudes of accelerations in the triaxial directions is recognized by the control unit 1, a time interval of the acceleration data G (gx, gy, gz, t) to be consecutively inputted into the operation input unit 5 is recognized as the time interval data dt by the control unit 1 (S10). Accordingly, the integral calculation is performed for the acceleration data G consecutively inputted into the operation input unit 5 with the time interval data dt by the control unit 1, and the velocity magnitude data V (vx, vy, vz, t) in the triaxial directions is calculated by the control unit 1 (see FIG. 7). For example, when acceleration data GI (gx1, gy1, gz1, t1) is recognized by the control unit 1 at time t1 and subsequently acceleration data G2 (gx2, gy2, gz2, t2) is recognized by the control unit 1 at time t2, velocity magnitude data V1 (vx1, vy1, vz1, t1) is calculated by the control unit 1 by causing the control unit 1 to perform the calculation of “∫[G2 (gx2, gy2, gz2, t2)−G1 (gx1, gy1, gz1, t1)]·dt” between the time t2 and the time t1. In a similar way to the above, when acceleration data G3 (gx3, gy3, gz3, t3) is recognized by the control unit 1 at time t3 succeeding the time t2, velocity magnitude data V2 (vx2, vy2, vz2, t2) is calculated by the control unit 1 by causing the control unit 1 to perform the calculation of “∫[G3 (gx3, gy3, gz3, t3)−G2 (gx2, gy2, gz2, t2)]·dt” between the time t3 and the time t2. Also, when acceleration data G4 (gx4, gy4, gz4, t4) is recognized by the control unit 1 at time t4 succeeding the time t3, velocity magnitude data V3 (vx3, vy3, vz3, t3) is calculated by the control unit 1 by causing the control unit 1 to perform the calculation of “∫[G4 (gx4, gy4, gz4, t4)−G3 (gx3, gy3, gz3, t3)]·dt” between the time t4 and the time t3.

When the integral calculation is further performed by the control unit 1 for thus calculated velocity magnitude data V with the time interval data dt, position data X of the controller 25 is calculated by the control unit 1. For example, position data X1 (x1, y1, z1, t1) of the controller 25 is calculated by the control unit 1 by causing the control unit 1 to perform the calculation of “∫[V2 (vx2, vy2, vz2, t2)−V1 (vx1, vy1, vz1, t)]·dt” between the time t2 and the time t1. In a similar way to this, position data X2 (x2, y2, z2, t2) of the controller 25 is calculated by the control unit 1 by causing the control unit 1 to perform the calculation of “∫[V3 (vx3, vy3, vz3, t3)—V2 (vx2, vy2, vz2, t2)]·dt” between the time t3 and the time t2.

It is possible to calculate the velocity magnitude data and the position data in each time by causing the control unit 1 to perform the above described series of calculations when the acceleration data G is recognized by the control unit 1.

### Object Moving Velocity Data Calculating Means

The bat moving velocity data is calculated by causing the control unit 1 to perform the calculation of multiplying the velocity magnitude data V by the modification coefficient a for the image display. This is the processing performed for modifying the velocity magnitude data calculated based on the acceleration data of the actually moved controller 25 into the moving velocity of the bat used in the game. For example, the moving velocity data of the bat is calculated by the control unit 1 by causing the control unit 1 to perform the calculation of multiplying the above calculated velocity magnitude data V1 and V2 of the controller 25 by the modification coefficient a (constant) or the modification coefficient α (V) depending on the velocity magnitude data V1 and V2 of the controller 25.

### Object Moving State Displaying Means

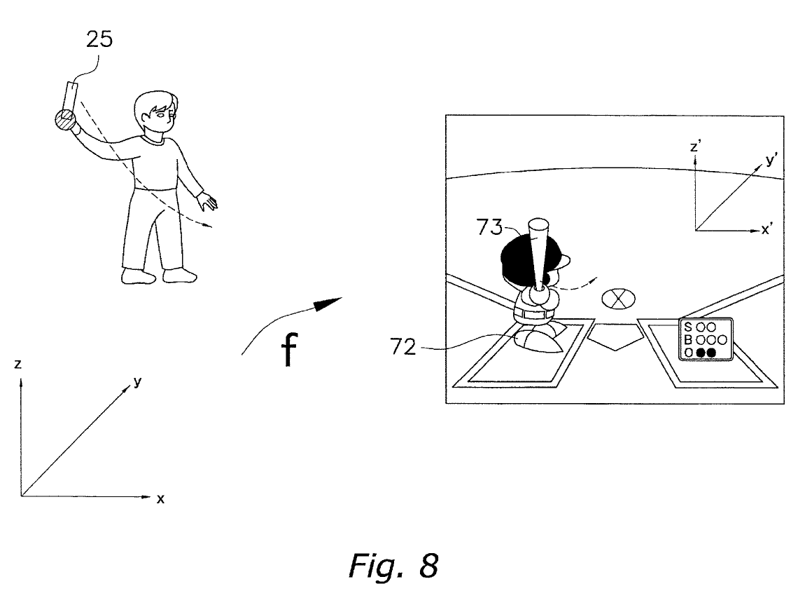

As illustrated in FIG. 8, the above calculated position data X1 and X2 of the controller 25 are converted into position data X′1 and X′2 for the television monitor 20. The position data X1 and X2 of the controller 25 are coordinates in the three-dimensional real space (space in which a game player swings his/her arm together with the controller 25). Therefore, the position data X1 and X2 of the controller 25 are herein converted into the position data X′1 and X′2 for the television monitor 20 in the three-dimensional game space. The conversion is performed by causing the control unit 1 to perform the mapping from the three-dimensional real space to the three-dimensional game space. For example, the conversion is performed by causing the control unit 1 to perform the calculation of “X′ (x′, y′, z′)=f·X (x, y, z)” with the map function f preliminarily determined in the game program. When the position data X′1 and X′2 in the three-dimensional game space are calculated by the control unit 1 by the mapping, the vector data setting the direction in which the bat is moved, such as the direction data for the bat, is calculated by the control unit 1 by causing the control unit 1 to calculate the difference between the position data X′2 and the position data X′1 in the three-dimensional game space. Accordingly, a state of the bat character 73 moving in the direction of the direction data for the bat is displayed on the television monitor 20.

### Other Embodiments

(a) In the above described embodiment, a case is exemplified that the home video game device is used as an example of a computer to which the game program is allowed to be applied. However, the game device is not limited to the above described embodiment. The present invention may be applied to a game device for which a monitor is separately provided, a monitor-integrated game device, a personal computer or a workstation that functions as a game device when a game program is executed therein, and the like, as well.

(b) A program for executing the above described game and a computer-readable recording medium in which the program is recorded are also included in the present invention. For example, a computer-readable flexible disk, a semiconductor memory, a CD-ROM, a DVD, a MO, a ROM cassette, and the like may be suggested as the recording medium other than the cartridge.

(c) In the above described embodiment, a case is exemplified that the moving velocity data of the bat at each instant time is calculated by multiplying the velocity magnitude data V at each instant time by the modification coefficient a for the image display. However, the calculating means of the moving velocity data of the bat is not limited to the above described embodiment, and may be configured to calculate the moving velocity data of the bat by causing the control unit 1 to perform the calculation of averaging the velocity magnitude data V at each instant time in the range from time ts at which the first acceleration data is recognized by the control unit 1 to time te at which the last acceleration data is recognized by the control unit 1 (see FIG. 7) and subsequently by multiplying the averaged velocity magnitude data V by the modification coefficient a for the image display.

### INDUSTRIAL APPLICABILITY

According to the present invention, with a controller in which an acceleration sensor is embedded, it is possible to cause an object image to move on an image display unit in conjunction with movement of the controller based on the acceleration data. Accordingly, it is possible to enhance amusement aroused when a game player operates a batter character.

The terms of degree such as “substantially”, “about” and “approximately” as used herein mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A computer readable medium storing a computer program of a vide game in which an object is displayed on a image display unit, the computer program comprising:
code for recognizing acceleration of an input device;
code for recognizing time duration of the acceleration;
code for calculating velocity of the input device on the basis of the acceleration and the time duration;
code for calculating velocity of the object based on the velocity of the input device; and
code for displaying the object moving at the velocity of the object on the image display unit.

2. The computer readable medium according to claim 1, the computer program further comprising
code for calculating speed of the input device by integrating the acceleration with the time duration,
code for calculating speed of the object corresponding to the speed of the input device, and
code for displaying the object moving at the speed of the object on the image display unit.

3. The computer readable medium according to claim 2, the computer program further comprising
code for calculating the speed of the input device by integrating the acceleration with the time duration and for calculating the position of the input device by integrating the speed of the object with the time duration,
code for calculating the velocity of the object corresponding to the speed of the input device, and
code for converting the position of the input device into position data on the image display unit,
code for calculating a direction of the object by using the converted position data, and
code for displaying the object moving at the velocity in the direction on the image display unit.

4. The computer readable medium according to claim 1, the computer program further comprising
code for judging whether or not the acceleration is greater than or equal to a predetermined value, and
code for recognizing the acceleration if the acceleration is greater than or equal to the predetermined value.

5. The computer readable medium according to claim 2, the computer program further comprising
code for calculating the velocity of the object by multiplying the speed of the input device by a coefficient.

6. The computer readable medium according to claim 2, the computer program further comprising
code for calculating the velocity of the object by referring to a table of the speed of the input device and the velocity of the object.

7. A vide game device of a video game in which an object is displayed on an image display unit, the video game device comprising:
an acceleration data recognizing unit configured to recognize acceleration of an input device;
a time interval data recognizing unit configured to recognize time duration of the acceleration;
an object moving velocity data calculating unit configured to calculate velocity of the input device on the basis of the acceleration and the time duration, and calculate velocity of the object based on the velocity of the input device; and
an object moving state displaying unit configured to display the object moving at the velocity of the object on the image display unit.

8. A method for controlling a video game in which an object is displayed on an image display unit, the method comprising:
recognizing acceleration of an input device;
recognizing time duration of the acceleration;
calculating velocity of the input device on the basis of the acceleration and the time duration;
calculating velocity of the object based on the velocity of the input device; and
displaying the object moving at the velocity of the object on the image display unit.
